(19) United States
(12) Patent Application Publication
(10) Pub. No.: US 2002/0147734 A1
(43) Pub. Date: Oct. 10, 2002

(54) Archiving method and system

(76) Inventors: Randall Scott Shoup, San Francisco, CA (US); Jean-Christophe Denis Bandini, San Carlos, CA (US)

Correspondence Address: PATENT DEPARTMENT, SKADDEN, ARPS, SLATE, MEAGHER & FLOM LLP, FOUR TIMES SQUARE, NEW YORK, NY, 10036, US

(21) Appl. No.: 09/828,365

(22) Filed: Apr. 6, 2001

(51) Int. Cl. G06F 7/00

(52) U.S. Cl. 707/200; 707/1

(57) ABSTRACT

A policy based archiving system receives data files in various formats and with various attributes. The archiving system examines each data file's attributes to correlate each data file with at least one policy by employing policy predicates. A policy is a collection of actions and decisions relating to the various storage and processing modules of the archiving system. In one aspect, the archiving system scans the content of a received data file to correlate the data file to a policy in accordance with the semantic content of the data file.

### FIELD OF THE INVENTION

The present invention relates to data storage systems, and particularly, to archiving systems.

### BACKGROUND

Data storage in an archiving system takes many forms. A data file, usually in the form of a document, is stored in various electronic formats, for varying durations, on various physical media, and is accessible by varying interfaces. The decision as to how the data file is treated by the archive is usually made on a file-by-file basis, whereby the archive administrator or the file's creator specifies how the file is to be treated. Such ad-hoc decision making consumes resources by forcing the archive designer to require a decision for each data file. Furthermore, the manner by which a data file is stored cannot be easily changed once the storage decisions are made. Thus, there is a need for a method for efficiently processing data files in an archiving system, which is easy to configure and does not require ad-hoc determinations.

### SUMMARY OF THE INVENTION

In accordance with the invention there is provided a policy based archiving system. Data files received into the system are correlated to at least one policy category. The policy categories that are correlated to a data file associate the file with a set of archive actions. The various processing components of the archive refer to the archive actions associated with a data file when processing the data file.

In one embodiment, the archiving system includes a reception module, which receives data files for archiving. Each data file includes at least one attribute. The archiving system also includes a correlation module, which associates a data file from the reception module with at least one policy profile by referring to at least one attribute of the data file and correlation predicates of the policy profile. A decision module associates archiving actions with a data file by referring to the policy profile, which was associated with the data file by the correlation module. Finally, the archiving system includes a data archiving module, which stores a data file in accordance with archive actions that are provided by the decision module.

In another embodiment, the invention includes a method for providing improved redundancy and data file longevity in an archive system. The method includes receiving into an archive system a data file, which is embodied in a format. The method then identifies at least one other format. The other format is identified by referring to predetermined format correlation data. Finally, the method stores a copy of the received data file in at least the other format so as to provide for improved redundancy and longevity in data file storage.

### BRIEF DESCRIPTION OF THE DRAWINGS

FIG. 1 illustrates the logical arrangement of components in an archiving system in accordance with the invention;

FIG. 2 illustrates the policy coverage scope for an exemplary set of policies in an archive system of the invention;

FIG. 3 illustrates the logical association between data files, policies, and actions in an archive system of the invention;

FIG. 4 is a flow diagram illustrating the operation of a correlation module; and

FIG. 5 is a flow diagram illustrating the operation of a formatting module.

### DETAILED DESCRIPTION

The structure and operation of an archiving system in accordance with the invention will now be discussed with reference to illustrations of an exemplary archiving system. First, the structure of an archiving system in accordance with the invention is discussed with reference to illustrations of components in an archiving system and illustrations of the logical interaction between data structures of the archiving system. Next, the operation of individual modules of the archiving system is discussed with reference to flow diagrams.

For the purpose of illustrating the operation of a system in accordance with the invention, the illustrated archiving system includes a limited number of operational modules. However, as may be appreciated, several additional modules and data structures may be employed in various embodiments of archiving systems. For example, archiving systems generally include an interface for retrieving stored data, such as a user desktop application or a Web based interface accessible through an Web browser which is not included in the example.

The following description refers to “data files” when discussing a system in accordance with the invention. The term “data files” is intended to include computer files, electronic data files, electronic files, and plain data files. Examples of data files include, text files (e.g., ASCII, UNICODE, SGML, HTML, XML, CSV), word processing files (e.g., MS Word files, Word Perfect files), spreadsheet files (e.g., MS Excel), presentation files (e.g., MS Power Point), video files (e.g., MPEG files, QuickTime files), sound files (e.g., MP3 files), application files (e.g., MS Project files), electronic mail files (e.g., electronic mail in MIME format, electronic mail in S/MIME format), image files (e.g., TIFF, GIF, JPEG), final form data files (e.g., Adobe PDF), archive files (e.g., ZIP files, TAR files), and executable binary files (e.g., MS Windows EXE and DLL files, Java class files). Moreover, it is appreciated that a single data file can contain more than one logical file such as in an archive file (zip or Unix's tar files), in an email with attachments, and in a WORD file with embedded data files.

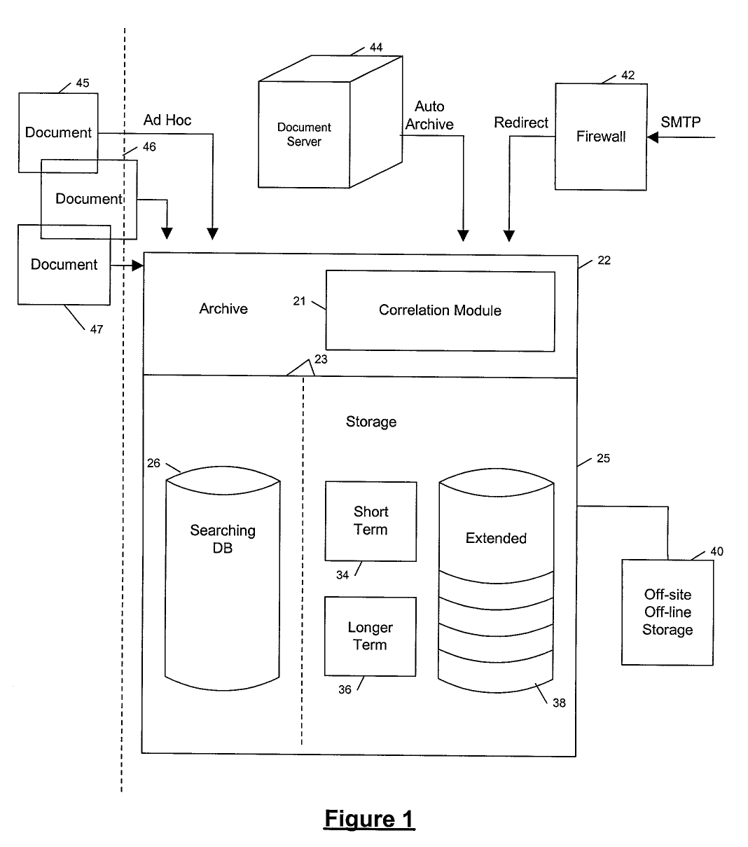

FIG. 1 illustrates an archiving arrangement in accordance with the invention. The archiving system 22 processes data files in two general stages: preprocessing and storage. For the preprocessing stage, the archiving system 22 includes a correlation module 21 that is employed to correlate policies with received data files.

To facilitate the storage stage, the archiving system 22 includes a storage portion 23 having two primary components. A first component is a searching database 26. The searching database 26 is employed to facilitate efficient searching of data files in the archive 22. In one embodiment, the searching database 26 includes information about each data file such as original file name, submitting party information, creation date, expiration date, author, file format, size, and location in the archive storage 25. In other embodiments, the searching database 26 contains additional information used for the implementation of the archiving system such as user information, access control information, and security information. Such searching databases are widely employed by archiving systems and are known in the art. In one embodiment, the searching database 26 is implemented as a relational databases (RDBMS) or by a text indexing and retrieval engine. A second component is a storage system 25. The storage system 25 typically includes a short term storage module 34, a longer term storage module 36, and an extended term storage module 38. In one embodiment, each storage module employs a different hardware technology. Such technologies include fast hard disk, slower hard disks, WORM jukebox, high density tapes, etc. In an alternate embodiment, the storage database 25 is also associated with an off-site storage module 40, which stores data at a remote location that is off-line. In one example the off-site off-line storage module 40 uses magnetic tapes, or Write-Once-Read-Many (WORM) storage. As may be appreciated, in other embodiments, the storage database 25 includes various subsets and combinations of these short, longer, and extended term storage elements. Both components of the storage portion 25, 26, are coupled to the correlation module 21 by an electronic communication link (not shown).

In operation, the archiving system 22 receives data files from various sources by way of several methods. In one form, data files 45, 46, and 47, are transmitted to the archiving system 22 on an ad-hoc basis in response to, for example, a user command to send a data file for archive. In another form, data files are archived automatically by a server 44 such as a financial transaction server that generates data files and prompts for automatic storage. Finally, data files are sometimes transmitted to the archiving system 22 from a firewall 42 by way of a redirect operation such as when an electronic mail message matches predetermined criteria by the operation of a policy by a firewall system, a proxy system, or a relay system. In one embodiment, the redirect operation comprises forwarding a copy of an e-mail message while allowing the original message to pass through. In one embodiment, these multiple ways of submitting a data file to the archiving system are implemented by a collection of plugin modules, which interact with the archive by using an Application Programming Interface (API).

The archiving system 22 receives data files and performs a correlation operation prior to forwarding the data files to the storage portion of the system 23. The data files are initially processed by the correlation module 21. The correlation module 21 refers to policy predicates (discussed below) and to attributes associated with each data file so as to assign policies to the data file. The data file is then transmitted to the storage portion of the archive system where archiving actions are performed on the basis of the policy or policies associated with the data file.

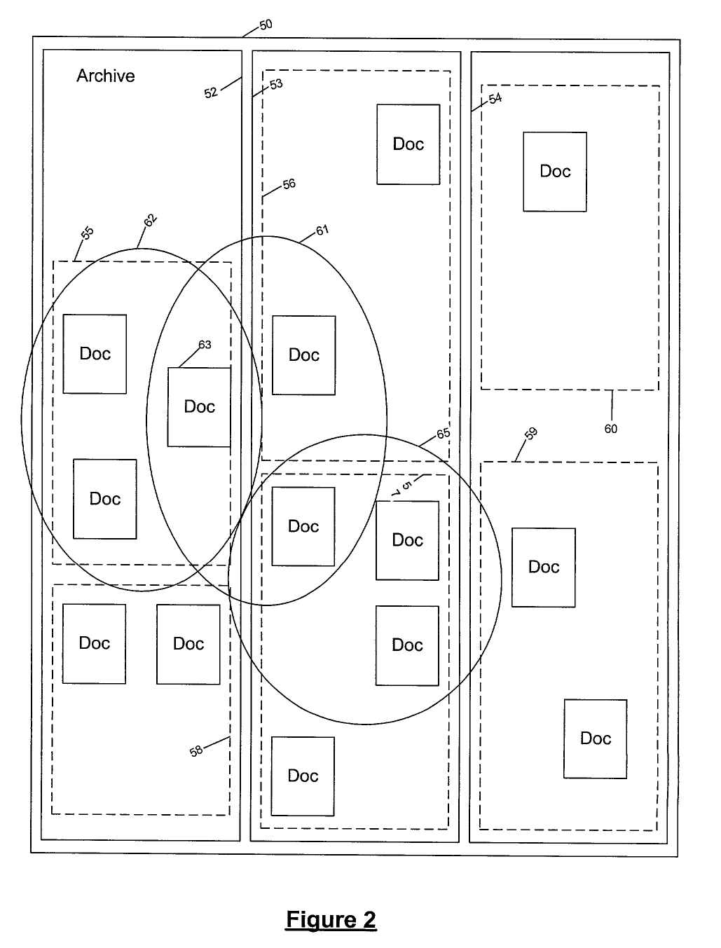

FIG. 2 illustrates policy coverage distribution for an embodiment of an archiving system of the invention. As discussed above, a policy refers to predicates and data file attributes so as to correlate data files to the policy. The illustration of FIG. 2 shows data files associated with one or more policies, as is often the case. A first policy 50 is applicable to an entire archive. The first policy 50 can be viewed as the ‘default policy.’ The first policy 50 thus includes all data files in the particular archive. Any actions associated with the first policy 50 are applicable to all data files added to the archive. As may be appreciated, in some embodiments more than one archive is maintained to store data files and accordingly more than one archive policy would apply. A second policy, is a company policy. The second policy, is preferably applicable to data files that belong to a particular corporation. In the illustrated example, there are three corporate policies 52, 53, and 54. The corporate policies are each divided into two division policies, 55 & 58, 56 & 57, and 59 & 60. Data file group policies 61, 62, and 65 are defined for groups of data files based on common attributes that are shared between data files in the group. As may be appreciated, the data file group policies 61, 62, and 65 can extend beyond the scope of data files covered by a single division or corporate policy. Finally, if specific actions are required for a particular data file, a file level policy is preferably associated with file.

In operation, data files that are in the archive system preferably fall within the scope of one or more policies. For example, a first data file 63 is within the scope of the archive policy 50, the first corporate policy 52, the first data file group policy 61, and the second data file group policy 62. Accordingly, action items and decisions associated with these policies 50, 52, 61, and 62 are inherited by the first data file 63. The actions and decisions associated with the data file 63 are referred to when the various modules of the archiving system process the data file.

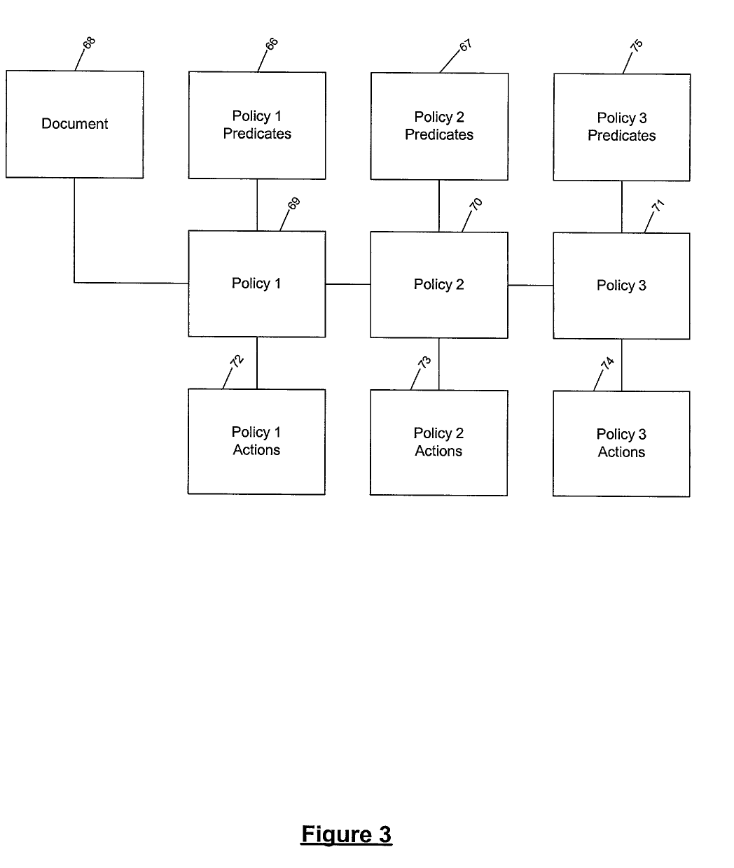

FIG. 3 illustrates the logical association between a data file, policies, and policy actions. A first data file 68 is associated with a first policy 69, a second policy 70, and a third policy 71. Each policy 69, 70, 71, is associated with a set of actions 72, 73, 74 and predicates 66, 67, 75, respectively. The predicates are employed to facilitate the correlation of a data file to a policy. Hence, the predicates are the logical link between a data file and a policy. By correlating the data file 68 to the policies 69, 70, 71, the data file inherits the actions 72, 73, 74 that are associated with the policies.

In one embodiment, when actions of two policies are in conflict with one another, the actions of the narrower policy supercede those of the more generally defined policy. In another embodiment, policies are pre-assigned priorities, which are employed to resolve conflicts such as by deciding that the policy with the higher priority is assigned to the data file when two policies are in conflict. For example, the archiving system receives a data file that belongs to both an archive-wide policy and a data file collection policy. The storage media defined in the archive-wide policy is a CD-ROM. The storage media defined in the data file collection policy is a hard disk drive. Therefore, there is a conflict in the storage media attribute for the document. The conflict is resolved because the data file group policy is more specific than the archive policy and thus supercedes the archive-wide policy. The data file is stored on the hard disk drive in accordance with the storage selection in the data file collection policy.

As may be appreciated, the actions associated with policies can be changed at any time, including after policies are correlated to data files, to easily modify the processing of data file groups. Preferably, the policy predicates remain constant while actions are modified. In another embodiment, the hierarchal relationship between policy may also be modified. Hence, the archiving method of the invention allows for modifying the way data files are processed by the archiving system after the data files have been stored in the archiving system.

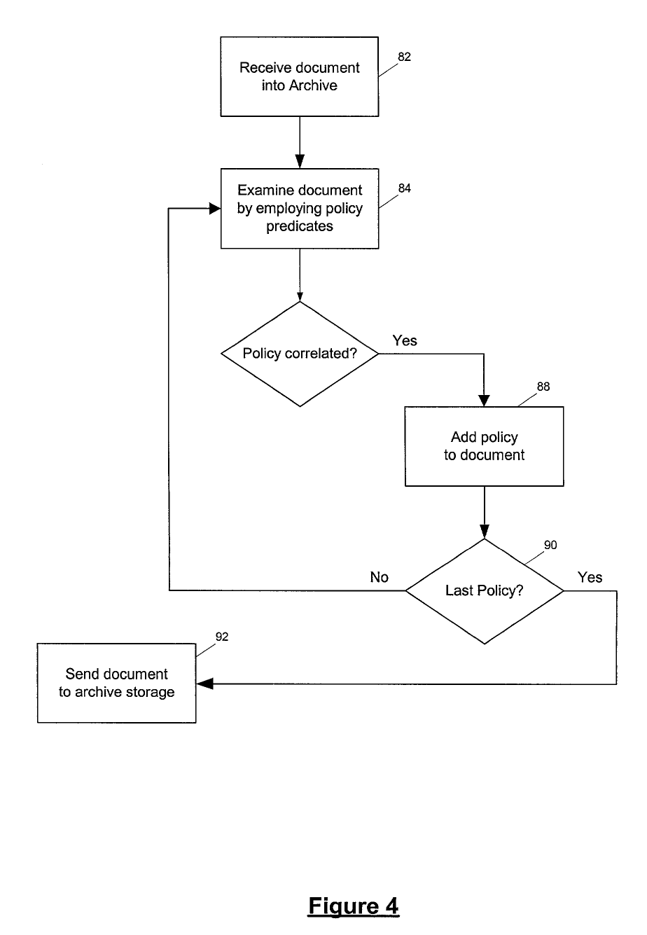

FIG. 4 illustrates the operation of the correlation module 21 when receiving data files into the archiving system 22. The correlation module 21 receives a data file from one of the various possible sources, as discussed above (step 82). The data file attributes are examined in accordance with the policy predicates (step 84). In one embodiment, policy predicates dictate that the semantic content of the data file is examined to extract key terms and phrases. In this embodiment, the extracted content is compared to predefined content to correlate the data file to a policy in accordance with the data file's semantic content. In one embodiment, the data file's semantic content is parsed by employing a parsing algorithm. The parsing algorithm preferably searches for content in accordance with rules. Each rule specifies a Boolean expression related to a policy predicate. For example, for a subject-based predicate, the corresponding rule, or Boolean expression, can be used to identify a regular expression in the data file, which is associated with a particular subject, such as detecting the term “law” more than five times in a data file to identify a legal document data file. The conditions of a rule are preferably related to one another through Boolean operators such as “AND,” “OR,” and “NOT.” The content parsing is preferably applicable to all levels of a data file, including any logically related sub-components such as attachments or included files.

In another embodiment, data file information, provided in predetermined data fields, is examined in accordance with policy predicates to correlate the data file to an archive policy. Such predefined field values preferably include source, size, creator, type, format, name, and recipient. The data file can further include custom defined attributes. As may be appreciated, various combination of predicate-based logical combinations can be provided by employing Boolean operators, as is known in the art.

Accordingly, a data file is correlated to policies in response to the data file attributes matching predicates of a policy. In one embodiment, the correlation module 21 assigns all matching policies to a data file. Hence, in this embodiment, a data file may be associated with more than one policy. In another embodiment, the correlation module 21 assigns only one policy to each data file. Such policy is preferably selected based on policy selection criteria such as highest match rate, policy hierarchy, or attribute match hierarchy. One example of the application of an attribute match hierarchy criterion is configuring the correlation module 21 to select a policy based on the data file's content rather than based on the data file length field.

In the illustrated flow diagram (FIG. 4), a data file can correlate to more than one policy. Hence, the correlation module 21 proceeds to evaluate other policies and to process the matched policies in accordance with the policy predicates. When policy predicates dictate that a data file is a match, the policy is added to the list of policies for the data file (step 88). In one embodiment, the policy associated with a data file is stored as a reference in the data file's data structure. The correlation module determines if the last policy was tested (step 90). If there are no more policies to test, the correlation module transfers the data file to the storage processing portion 23 for further processing (step 92). In another embodiment, the data file is transferred to a preprocessing module that formats the data file for storage. Preferably, the data file is transmitted to the storage processing portion 23 along with an indicator that facilitates the identification of the policies associated with the data file. In one embodiment, a global correlation table is employed to identify the policies that are associated with particular data files. In another embodiment, each data file is associated with a data structure that stores policy identification data, by preferably using the database 26.

In one embodiment, the archiving inquiries that depend on the data file's policy include how long to store the data file in the archive, how the data file is to progress between term-storage modules (aging), which format the data file is to be stored as, whether the data file should be archived, whether the data file should be quarantined, how the data file is indexed, whether the data file should be compressed, whether the data file should be encrypted, whether the data file should be digitally signed, whether special access control should be enforced at retrieval time, whether the data file should be digitally notarized or time-stamped (possibly with a 3^{rd} party trusted service), whether the data file should be stored at different geographical location when the storage system 25 is geographically distributed for disaster recovery, etc. In other embodiments, additional actions depend on data file policy. As may be appreciated, these actions are preferably selected, and are associated to a policy, in accordance with particular attributes of the embodiment.

Preferably, the attributes that are employed to correlate a policy to data files are stored in a policy profile that is accessible to the correlation module 21. In one embodiment, policy predicates are defined by an algorithm that is executed as a macro. In another embodiment the correlation criteria is a collection of attribute values corresponding to the policy's scope of coverage.

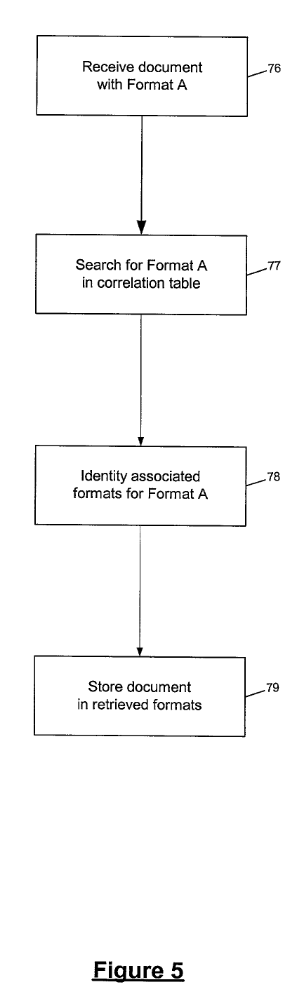

FIG. 5 illustrates the operation of the archive system when storing data files in multiple formats. In one aspect of the invention, the archiving system reduces the need to convert data files from stored format to another format by storing multiple formats of data files. The following discussion illustrates one embodiment of the multiple format storage feature. A data file is received into the archiving system 22 (step 76). The data file is in a particular data file format, format “A” in the example provided. A format lookup table is available to the archiving system for determining which data file formats correspond to the format in which the received data file is embodied (step 77). The format lookup table preferably stores data file formats that are often converted between. For example, one possible entry is: WORD format, WORDPERFECT format, and PDF format. Accordingly, the archive system searches the format lookup table for data file format “A” in response to receiving a data file in format “A” into the system. The archive system identifies at least one other format that is associated with format A in accordance with the format lookup table (step 78). The archive system then proceeds to store the received data file in at least one of the formats that are associated with format “A.”

As may be appreciated, the data file is now stored in more than one format. The multiple formats facilitate the multi-facet extraction of data files from the archiving system, thus eliminating the need for post extraction conversion. A user that employs a program that is different from the program used to create the data file, and which requires a different data file format, is able to extract the data file in a format employed by the program, as long as such format was provided in the format correlation table for the original data file format. Furthermore, the multi-facet storage implementation extends the useful life of a data file by increasing the likelihood that a version of the data file will be useable in the future. As is known, application program versions do not always support data files from an earlier version of the application. Accordingly, often times files created by an earlier version of an application are not usable when an application, several versions later, attempts to read the data file. Accordingly, the storage of a data file in multiple formats increases the likelihood that one of the formats will still be useful. This is especially true when the converted-to format is a simpler format than the original, such as plain text data from a WORD data file, because simple format data is usually readable and is usable to many applications.

Storing more than one format for the same data file provides the advantage of being able to view the data file using different software tools. The longevity of software tools supporting a particular format is usually significantly shorter than the required useful life of a data file. Therefore, the multiple format storage allows for using new software support tools for the same data file, thereby increasing the useful life of the data file. Not all formats are equally suited for indexing. Some formats are more appropriate for indexing than others. For example, it is much easier to search ASCII format than text in a rich-text format. Finally, the storage of multiple formats and providing user access to the formats can significantly enhance the usability of the system as users are not restricted to the software tool of the original format.

Although the present invention was discussed in terms of certain preferred embodiments, the invention is not limited to such embodiments. Rather, the invention includes other embodiments including those apparent to a person of ordinary skill in the art. Thus, the scope of the invention should not be limited by the preceding description but should be ascertained by reference to the claims that follow.

What is claimed is:

1. A data file archive system, comprising:
a reception module, the reception module receiving data files for archiving, each data file including at least one attribute;
a correlation module, the correlation module associating at least one policy profile with a data file from the reception module, the policy profile including correlation predicates associated with data file attributes, the correlation module associating a policy profile by referring to said at least one attribute of the data file and correlation predicates of the policy profile;
a decision module, the decision module associating archiving actions with a data file by referring to the policy profile that is associated with the data file; and
a data archiving module, the data archiving module storing a data file in accordance with archive actions associated with the data file by the decision module.

2. The system of claim 1, wherein the data file is a document.

3. The system of claim 2, wherein the policy profile applied to a data file is selected from the group consisting of an organization policy, an archive policy, a data file group policy, and a data file policy.

4. The system of claim 2, wherein the data file is a plain-text document.

5. The system of claim 1, wherein the data file contains several logical electronic data.

6. The system of claim 5, wherein the data file is a compressed archive file.

7. The system of claim 1, wherein the data file is an XML file.

8. The system of claim 1, wherein the data file is an electronic message file.

9. The system of claim 1, wherein the policy profiles in the correlation module are defined for overlapping sets of data files.

10. The system of claim 1, wherein said data file includes semantic content, said at least one attribute referred to by the correlation module includes the semantic content of the data file.

11. The system of claim 10, wherein the semantic content is textual content.

12. The system of claim 1, wherein said attributes are selected from the group consisting of data file format, time of receipt, predetermined field values, custom attributes, and reception method.

13. Method for archiving a data file in an archiving system having policies for controlling the archiving of data files, the policies including predicates, the policies associated with archiving actions, comprising:
receiving a data file into an archiving system, the data file including attributes;
examining the data file attributes by employing policy predicates associated with policies of the archiving system;
correlating at least one policy to the data file by reference to said examining; and
archiving the data file in accordance with actions corresponding to at least one policy from said correlating of policy to the data file.

14. The system of claim 1, wherein the actions are selected from the group consisting of archive or not, duration of archive, aging method, archive format selection, archive indexing method, and quarantine data file.

15. A method for providing redundancy in an archive system, comprising:
receiving a data file into an archive system, the data file embodied in a first data file format;
identifying a second data file format, the second format identified by referring to predetermined format correlation data; and
storing a copy of the received data file, the copy stored in said second data file format to provide for redundancy in data file storage.

16. A method of archiving data files, comprising:
(1) receiving a data file into an archive system;
(2) storing the data file in a first format;
(3) searching a format list corresponding to said first format, the format list including one or more formats;
(4) identifying at least one format from said format list that the data file is not stored in; and
(5) storing a copy of the data file in said at least one identified format.

17. The method of claim 16, further comprising:
periodically repeating steps 3, 4, and 5; and
periodically updating said format list.
